(19) United States
(12) Patent Application Publication
(10) Pub. No.: US 2023/0194757 A1
(43) Pub. Date: Jun. 22, 2023

(54) OPTICAL DEVICES INCLUDING METASTRUCTURES AND METHODS FOR FABRICATING THE OPTICAL DEVICES

(71) Applicant: NIL Technology ApS, Kongens Lyngby (DK)

(72) Inventors: Jesper Fly Hansen, Copenhagen (DK); Villads Egede Johansen, Denmark (DK); Maksim Zalkovskij, Copenhagen (DK); Brian Bilenberg, Ølstykke (DK); James Eilertsen, Skodsborg (DK)

(21) Appl. No.: 17/925,941

(22) PCT Filed: May 17, 2021
(86) PCT No.: PCT/EP2021/063004

§ 371 Date: Nov. 17, 2022

Related U.S. Application Data
(60) Provisional application No. 63/026,279, filed on May 18, 2020.

(51) Int. Cl. G02B 1/00; G02B 1/18; G02B 7/00; G02F 1/01

(52) U.S. Cl. CPC G02B 1/002; G02B 1/18; G02B 7/003; G02F 1/0102; G02B 2207/101

(57) ABSTRACT

Manufacturing an optical device includes providing a substrate (102) having a polymeric layer (104) on a surface of the substrate, forming openings in the polymeric layer, and depositing a material in the openings to form meta-atoms (114, 214) of a first metastructure. Adjacent ones of the meta-atoms are separated from one another by polymeric material of the polymeric layer. Optical devices that include one or more metastructures in which meta-atoms are separated from one another by polymeric material are described, as are modules that incorporate the optical devices.

### FIELD OF THE DISCLOSURE

The present disclosure relates to optical devices that include one or more metastructures.

### BACKGROUND

A metasurface refers to a surface with distributed small structures (e.g., meta-atoms) arranged to interact with light in a particular manner. For example, a metasurface can be a surface with a distributed array of nanostructures. The nanostructures may, individually or collectively, interact with light waves. For example, the nanostructures or other meta-atoms may change a local amplitude, a local phase, or both, of an incoming light wave.

### SUMMARY

The present disclosure describes optical devices that include one or more metastructures, and methods of manufacturing the metastructures. Optical devices incorporating one or more of the metastructures may be integrated into modules that house one or more optoelectronic devices (e.g., light emitting and/or light sensing devices). The metastructure can be used, for example, to modify one or more characteristics (e.g., phase, amplitude, angle, etc.) of an emitted or incoming light wave as it passes through the metastructure. In some instances, the optical device may provide greater mechanical stability for the metastructure and also may help protect the metastructure from physical, chemical and/or environmental degradation.

For example, in one aspect, the present disclosure describes a method of manufacturing an optical device that includes providing a substrate having a polymeric layer on a surface of the substrate, forming openings in the polymeric layer, and depositing a material in the openings to form meta-atoms of a first metastructure. Adjacent ones of the meta-atoms are separated from one another by polymeric material of the polymeric layer.

Some implementations include one or more of the following features. For example, in some instances, the method includes forming the openings in the polymeric layer by an imprinting process. The imprinting process can include, for example, pressing a stamp into the polymeric layer, and the method can include hardening the polymeric material before separating the stamp from the polymeric layer. In some cases, the method includes curing the polymeric before depositing the material in the openings to form the meta-atoms of the first metastructure.

The first metastructure may include a one-dimensional, a two-dimensional or three-dimensional pattern of meta-atoms.

In some implementations, the method includes depositing the material in the openings by atomic layer deposition. In some instances, the material deposited in the openings to form the meta-atoms is titanium dioxide. In some cases, other materials may be used for the meta-atoms. In some cases, depositing a material in the openings to form the meta-atoms results in a layer of the material on the first metastructure, and the method further includes removing the layer of the material to expose the meta-atoms.

In some instances, the method includes providing a protective polymeric layer over the first metastructure. In some cases, a protective layer is provided over the first metastructure, wherein the protective layer has a hydrophobic or hydrophilic surface,

In some instances, the method includes providing a second polymeric layer over the first metastructure, and forming a second metastructure in the second polymeric layer. In some implementations, forming the second metastructure includes forming openings in the second polymeric layer, and depositing a material in the openings of the second polymeric layer to form meta-atoms of the second metastructure, wherein adjacent ones of the meta-atoms of the second metastructure are separated from one another by polymeric material of the second polymeric layer. In some cases, at least one of the materials, dimensions and/or optical characteristics of the first and second metastructures differ from one another.

The present disclosure also describes an optical device that includes a substrate, and a first metastructure disposed on the substrate. The first metastructure includes meta-atoms separated from one another by polymeric material.

Some implementations include one or more of the following features. For example, in some cases, polymeric material is present between the meta-atoms and the substrate. In some instances, the substrate is composed of fused silica.

In some instances, the meta-atoms are composed of titanium dioxide. Each of the meta-atoms may have a height, for example, that is at least ten times greater than its width. In some cases, each of the meta-atoms has a height of 1 μm+20-30%, and has a diameter in a range of 60-400 nm. Other materials for, and dimensions of, the meta-atoms may be applicable in some implementations.

In some implementations, the optical device includes a protective polymeric layer over the first metastructure. The optical device may include a protective layer over the first metastructure, wherein the protective layer has a hydrophobic or hydrophilic surface.

In some cases, the optical device includes a second metastructure disposed on the substrate, wherein the first and second metastructures are disposed in the same plane as one another. The first and second metastructures can be separated from one another by an optical isolation region.

In some instances, the optical device includes a second metastructure disposed over the substrate, wherein the second metastructure is in a plane different from the first metastructure. In some cases, the second metastructure at least partially overlaps a position of the first metastructure. In other cases, the second metastructure does not overlap a position of the first metastructure. At least one of the materials, dimensions and/or optical characteristics of the first and second metastructures may differ from one another in some instances.

In some implementations, the optical device includes a protective polymeric layer over the second metastructure. In some cases, the optical device includes a protective layer over the second metastructure, wherein the protective layer has a hydrophobic or hydrophilic surface.

The second metastructure can include a plurality of meta-atoms separated from one another by polymeric material. In some cases, the meta-atoms of the second metastructure are composed of titanium dioxide. In some implementations, other materials may be used for the meta-atoms of the second metastructure.

The present disclosure also describes modules that include an optical device having a metastructure. The modules may include light emitting components, light sensing components, or both light emitting and light sensing components. The metastructure(s) may be disposed so as to intersect an emitted or incoming light wave and to modify one or more characteristics (e.g., phase, amplitude, angle, etc.) of the emitted or incoming light wave as it passes through the metastructure.

Other aspects, features and advantages will be apparent form the following detailed description, the accompanying drawings, and the claims.

### BRIEF DESCRIPTION OF THE DRAWINGS

FIGS. 1A-1D illustrate a method of fabricating an optical device that includes an embedded metastructure.

FIGS. 2A-2H illustrate a method of fabricating an optical device that includes embedded metastructures.

FIGS. 3-6 illustrate examples of optical devices that includes embedded metastructures.

FIG. 7 illustrates an example of a light sensing module including an optical device having one or more metastructures.

FIG. 8 illustrates an example of a light emitting module including an optical device having one or more metastructures.

FIGS. 9-11 illustrate examples of multi-channel optoelectronic modules including an optical device having one or more metastructures.

FIGS. 12-13 illustrate examples of optical devices including metastructures and integrated diffractive optical elements.

### DETAILED DESCRIPTION

When meta-atoms (e.g., nanostructures) of a metasurface are in a particular arrangement, the metasurface may act as an optical element such as a lens, lens array, beam splitter, diffuser, polarizer, bandpass filter, or other optical element. In some instances, metasurfaces may perform optical functions that are traditionally performed by refractive and/or diffractive optical elements. The meta-atoms may be arranged, in some cases, in a pattern so that the matastructure functions, for example, as a lens, grating coupler or other optical element. In other instances, the meta-atoms need not be arranged in a pattern, and the metastructure can function, for example, as a fanout grating, diffuser or other optical element. In some implementations, the metasurfaces may perform other functions, including polarization control, negative refractive index transmission, beam deflection, vortex generation, polarization conversion, optical filtering, and plasmonic optical functions.

In some applications, contaminants on the nanostructures may damage the nanostructures mechanically and/or chemically, or may impair the proper optical functioning of the nanostructures. Inoperable nanostructures may, beside leading to a non-working device, compromise safety. For example, a laser beam may be deflected, by a drop of water on a metasurface, into an eye of a user. As another example, a wet metasurface may have a changed refractive index surrounding the metasurface, and the changed refractive index may alter the optical properties of the metasurface, leading to collimated light passing through the metasurface and into an eye of a user.

The present disclosure describes techniques that, in some instances, can help provide greater mechanical stability for the metastructure and also may help protect the metastructure from physical, chemical and/or environmental degradation. As described below, such metastructures can include a polymeric material disposed between the individual nanostructures, or other meta-atoms, of the metastructure. Thus, each of the individual nanostructures, for example, can be surrounded laterally by the polymeric material. Further, in some instances, a protective layer of polymeric material is provided over the metastructure.

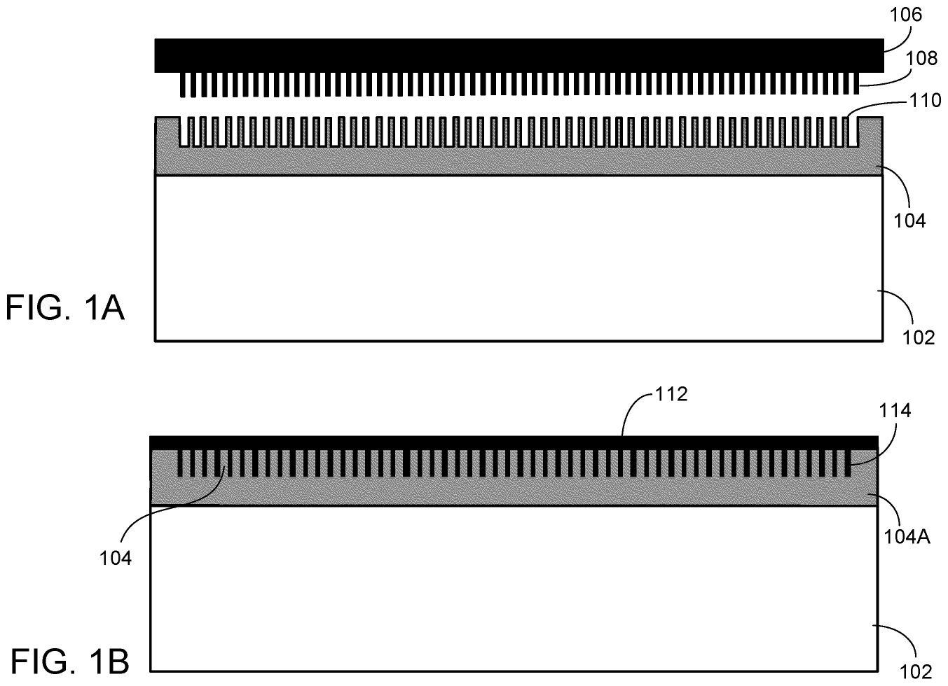

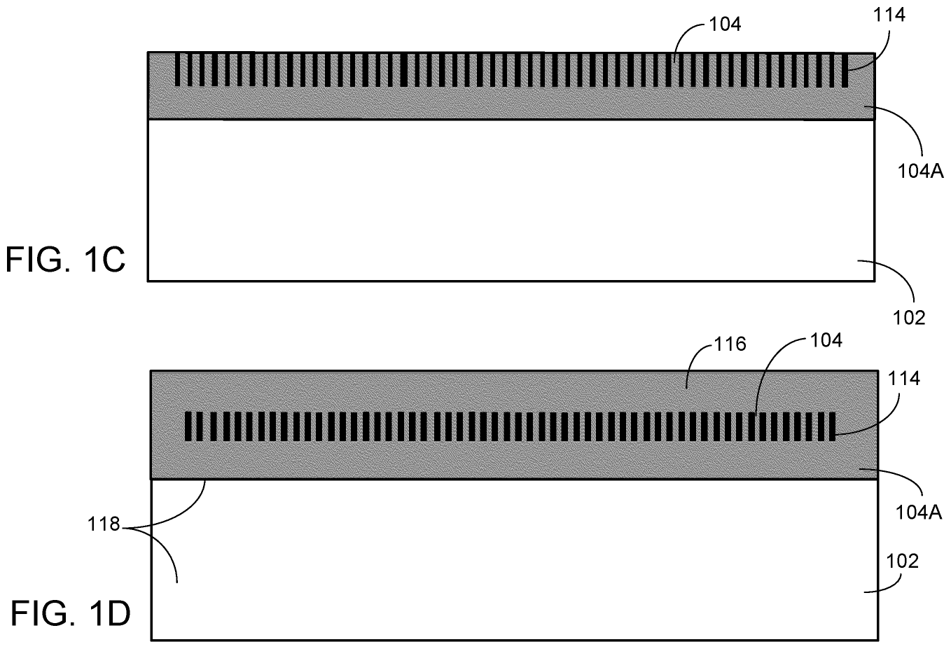

FIGS. 1A-1D illustrate manufacturing steps for forming an optical device that includes a metastructure.

As illustrated in FIG. 1A, a substrate 102 has a polymeric layer 104 deposited on its surface. The substrate may be selected to be optically transmissive with respect to a particular wavelength or range of wavelengths of radiation (e.g., infra-red (IR) or visible light) depending on the application(s) in which the metastructer is to be used. For example, in some instances, the substrate 102 may be composed of fused silica. Different materials may be suitable for other implementations. In some cases, the substrate 102 may be composed of reflective material. Examples of the polymeric layer 104 include a photoresist or thermally curable resist. Other polymeric materials may be suitable for some implementations.

An arrangement of openings 110 that correspond to the locations of the meta-atoms is formed in the polymeric layer 104. In some cases, the height of the meta-atoms may vary across the metastructure. In some cases, the arrangement of openings 110 may be a one-dimensional, a two-dimensional or three-dimensional pattern, depending on the implementation. The openings 110 in the polymeric layer 104 can be formed, for example, by an imprinting technique. In some instances, the polymeric layer 104 has a refractive index in the range of 1.45-1.55. Using a polymeric material having a relatively low index of refraction can help achieve a relatively small aspect ratio for the resulting metastructure, which in turn can help reduce the overall height of the structure. If a thermally curable resist is used, heating the resist may be required in some instances before the imprinting.

As shown in the example of FIG. 1A, the polymeric layer 104 has been imprinted using a stamp 106 having an arrangement of features 108 that project toward the substrate 102. The arrangement of features 108 represents an inverse image of the desired arrangement of openings 110. Thus, in some cases, the arrangement of features 108 may be a one-dimensional, two-dimensional or three-dimensional pattern. The stamp 106 is brought into contact with the polymeric layer and is pressed towards the substrate 102. The imprinting imparts an inverse image of the features 108 into the polymeric layer 104, as indicated by FIG. 1A, thereby creating the arrangement of openings 110. In some implementations, the imprinting process involves embossing or replication. Prior to separating the stamp 106 from the polymeric layer 104, the polymeric layer 104 can be cured (for example, using an ultraviolet (UV) flash cure in the case of photoresist; or a thermal cure).

In some implementations, the height of the features 108 extending from the stamp 106 is slightly less than the thickness of the polymeric layer 104. Therefore, after the imprinting process, a thin layer of polymeric material 104A may remain between the surface of the substrate 102 and the openings 110 in the polymeric layer 104. An advantage that may be achieved in some instances is that the stamp 106 is not damaged when brought into contact with the polymeric material (i.e., the stamp 106 does not collide with the substrate so as to damage the nanostructures incorporated into the stamp).

Next, as shown in FIG. 1B, a metamaterial 112 is deposited over the polymeric layer 104 so as to fill the openings 110 and form the individual meta-atoms 114 of the metastructure. The metamaterial 112 can be deposited, for example, by atomic layer deposition (ALD). A suitable metamaterial 112 for the meta-atoms 114 is titanium dioxide (TiO₂), which has a high refractive index relative to the material that surrounds it. Other materials, such as oxides, nitrides, metals or dielectrics, may be used in some instances. Materials including one or more of zirconium oxide (ZnO₂), tin oxide (SnO₂), indium oxide (In₂O₃), or tin nitride (TiN) can be used as the metamaterial 112 in some implementations In general, it is desirable that the metamaterial 112 have a relatively high index of refraction and relatively low optical loss.

Each meta-atom 114 may have the shape, for example, of a post, and the meta-atoms 114 may be arranged in a two-dimensional array. In some implementations, the meta-atoms 114 are strips arranged in a one-dimensional array. In some implementations, the meta-atoms 114 are arranged in other patterns, e.g., in concentric rings. Each meta-atom 114 composed, for example, of TiO₂ is laterally surrounded by the polymeric material 104 and adjacent meta-atoms are separated from one another by the polymeric material. Further, as noted above, a thin layer of polymeric material 104A may remain between the surface of the substrate 102 and the meta-atoms 114.

Next, as shown in FIG. 1C, the top layer of metamaterial 112 is removed, for example, by etching back the material to expose the meta-atoms 114 embedded in the polymeric layer 104. Suitable techniques for removing the top layer of metamaterial 112 include, for example, plasma etching, chemical etching or chemical-mechanical polishing (CMP).

Each resulting meta-atom 114 may have dimensions of, for example, tens of nanometers (nm) or hundreds of nm. In some implementations, each meta-atom 114 has a dimension between 10 nm and 100 nm. In some implementations, each meta-atom 114 has a dimension between 100 nm and 500 nm. In some implementations, each meta-atom 114 has a dimension of less than 1 μm. In some implementations, each meta-atom 114 has a dimension of less than 10 μm. In some cases, each meta-atoms has a height that is on the order of ten times greater than its width. In a particular example, the meta-atoms have a height of 1 μm +20-30%, and have a diameter in the range of 60-400 nm. The dimensions of the meta-atoms may differ for other implementations.

As shown in FIG. 1D, in some instances, a protective layer 116 then is deposited over the metastructure, including the meta-atoms 114. The layer 116 can help protect the metastructure from physical, chemical and/or environmental degradation. In some instances, the protective layer 116 is composed of a photoresist material that is spun on and then cured. Other materials such as polymers or spin-on glass may be used as well for the protective layer 116. Preferably, the protective layer 116 has a refractive index the same as, or substantially the same as that of the polymeric layer 104. In some cases, the thickness of the protective layer 116 is at least two times the wavelength of light for applications in which the metastructure is to be used.

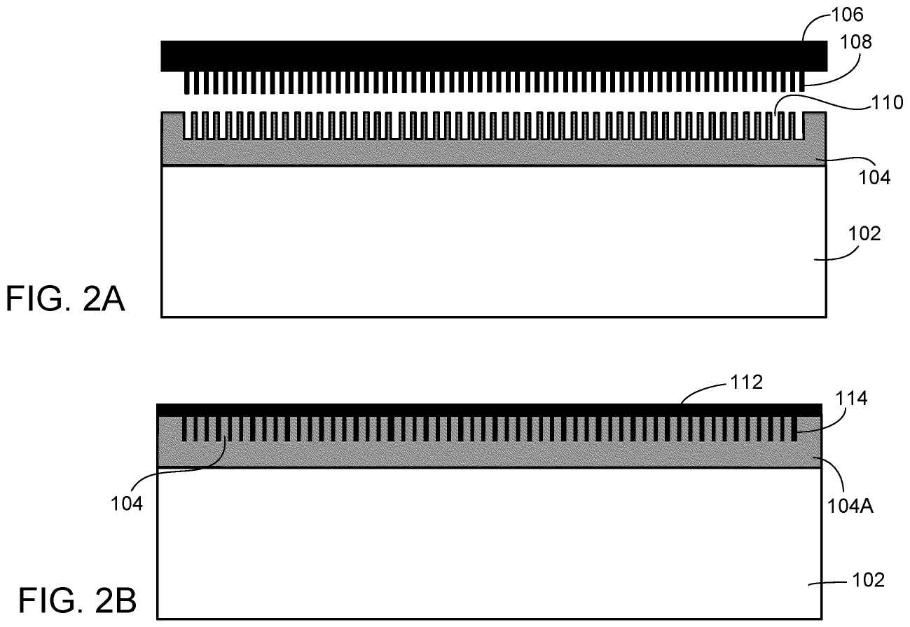

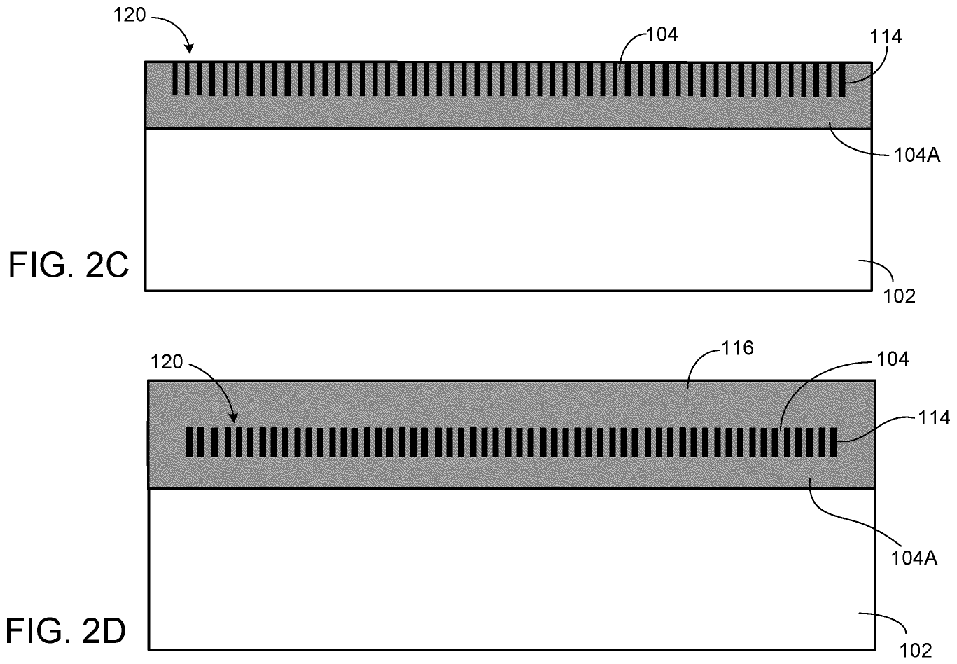

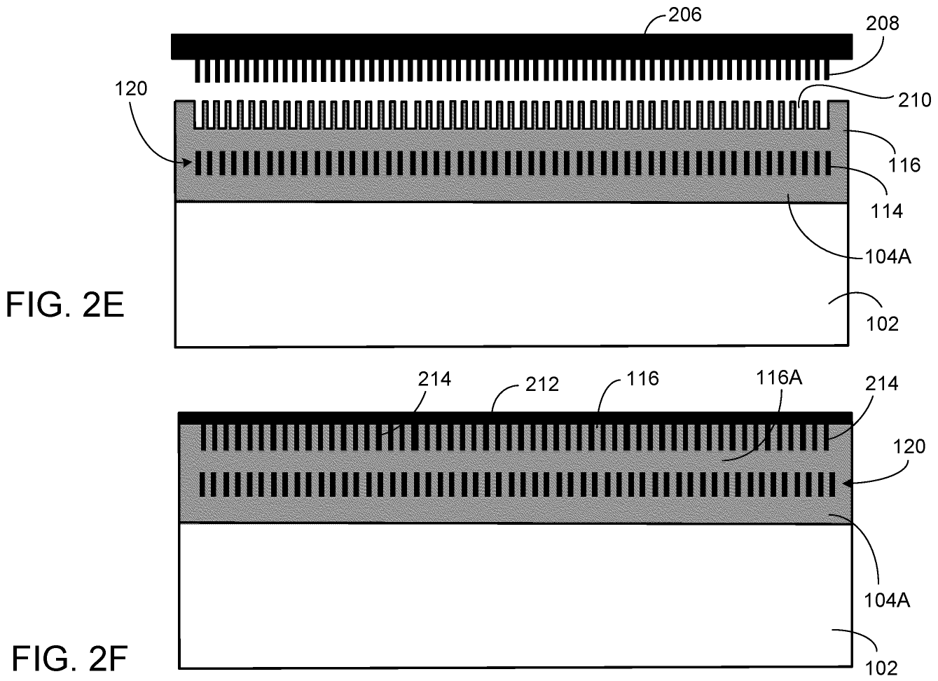

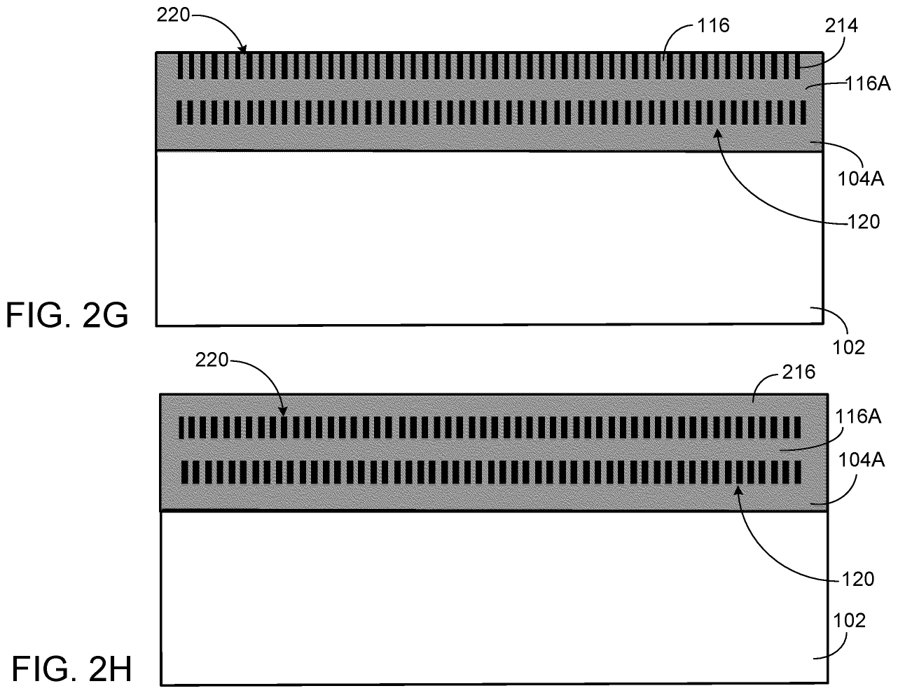

In some cases, an optical device includes two metastructures, one over the other. An example of fabrication steps for forming such a device are illustrated in FIGS. 2A-2H. Formation of the first metastructure, as shown in FIGS. 2A-2D, can be substantially the same as described in FIGS. 1A-1D. In the illustrated example of FIG. 2D, the layer 116 is composed of polymeric material (e.g., photoresist), and formation of a second metastructure is described in connection with FIGS. 2E-2H. In particular, prior to curing the polymeric layer 116, an arrangement of openings 210 that correspond to the locations of the meta-atoms for the second metastructure is formed in the polymeric layer 116 (FIG. 2E). The polymeric layer 116 is imprinted using a second stamp 206 having an arrangement of features 208 that project toward the substrate 102. The second stamp 206 and arrangement of features 208 in FIG. 2E may be the same as, or may differ from, the stamp 106 and arrangement of features 108 in FIG. 2A. The arrangement of features 208 represents an inverse image of the desired arrangement of openings 210 formed in the polymeric layer 116. Here too, the stamp 206 is brought into contact with the polymeric layer 116 and is pressed towards the substrate 102. The imprinting imparts an inverse image of the features 208 into the polymeric layer 116, as indicated by FIG. 2E, thereby creating the arrangement of openings 210. In some cases, prior to separating the stamp 206 from the polymeric layer 116, the polymeric layer 116 can be cured, for example, using an ultraviolet (UV) flash cure or a thermal cure. Other details of the imprinting process of FIG. 2E can be the same as or similar to those described above in connection with FIG. 1A.

After separating the stamp 206 from the polymeric layer 116 (FIG. 2E), the operations described previously in connection with FIGS. 1B-1D are substantially repeated, as illustrated in FIGS. 2F-2H. Thus, a metamaterial 212 (e.g., TiO₂) is deposited over the polymeric layer 116 so as to fill the openings 210 and form the individual meta-atoms 114 of the metastructure. The metamaterial 212 can be deposited, for example, by atomic layer deposition (ALD). A suitable material 212 for the meta-atoms 214 is titanium dioxide (TiO₂), although other materials, such as oxides, nitrides, metals or dielectrics, may be used in some instances, as described above in connection with the metamaterial 112. Each meta-atom 214 may have the shape, for example, of a post, and the meta-atoms 214 may be arranged in a two-dimensional array. In some implementations, the meta-atoms 214 are strips arranged in a one-dimensional array. In some implementations, the meta-atoms 214 are arranged in other patterns, e.g., in concentric rings. In any event, each meta-atom 214 composed, for example, of TiO₂is laterally surrounded by the polymeric layer 216. Further, a thin layer of polymeric material 216A may remain between the first metastructure 120 and the second metastructure 220.

Next, as shown in FIG. 2G, the top layer of metamaterial 212 is removed, for example, by etching back the material to expose the meta-atoms 214 embedded in the polymeric layer 116. Suitable techniques for removing the top layer of metamaterial 212 include, for example, plasma etching, chemical etching or chemical-mechanical polishing (CMP).

Each resulting meta-atom 214 may have dimensions of, for example, tens of nanometers (nm) or hundreds of nm. In some implementations, each meta-atom 214 has a dimension between 10 nm and 100 nm. In some implementations, each meta-atom 214 has a dimension between 100 nm and 500 nm. In some implementations, each meta-atom 214 \has a dimension of less than 1 μm. In some implementations, each meta-atom 214 has a dimension of less than 10 μm. In some cases, each meta-atoms has a height that is on the order of ten times greater than its width. In a particular example, the meta-atoms have a height of 1 μm +20-30%, and have a diameter in the range of 60-400 nm. The dimensions of the meta-atoms may differ for other implementations.

As shown in FIG. 2H, in some instances, a protective layer 216 then is deposited over the second metastructure 220. The layer 216 can help protect the second metastructure 220 from physical, chemical and/or environmental degradation. In some instances, the protective layer 216 is composed of a photoresist material that is spun on and then cured. Other materials such as polymers or spin-on glass may be used as well for the protective layer 216. Preferably, the protective layer 216 has a refractive index the same as, or substantially the same as that of the polymeric layer 116. In some cases, the thickness of the protective layer 216 is at least two times the wavelength of light for applications in which the metastructure is to be used. Other details of the fabrication process of FIGS. 2F-2H can be the same as, or similar to, those described in connection with FIGS. 1B-1D.

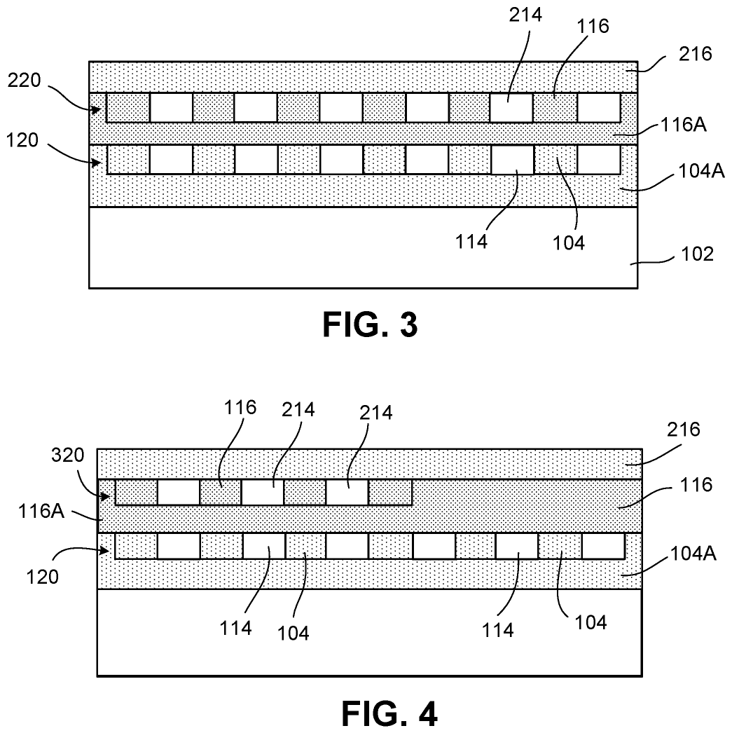

For devices that have multiple metastructures embedded in layers of polymeric material, the materials, dimensions and/or optical characteristics of the metastructures may be the same as one another or may differ from one another. FIG. 3 illustrates an example of an optical device having a first metastructure 120 and a second metastructure 220. The first metastructure 120 includes meta-atoms 114 laterally surrounded by portions of the first polymeric layer 104. The second metastructure 220 includes meta-atoms 214 laterally surrounded by portions of the first polymeric layer 116. The first metastructure 120 is separated from the substrate 102 by a portion 104A of the first polymeric layer 104, and the second metastructure 220 is separated from the first metastructure 120 by a portion 116A of the second polymeric layer 116. A protective polymeric or other layer 216 is disposed over (or in) the second metastructure 220 and can help provide protection from moisture and other physical, chemical and/or environmental degradation.

In some cases, the materials for the polymeric layers 104, 116 have different properties from one another. For example, they may have different coefficients of thermal expansion (CTE) and/or different glass transition temperatures (Tg). In some cases, the CTE of the first polymeric material is greater than the CTE of the second polymeric material. This feature may provide greater mechanical stability in some instances. Likewise, in some implementations, the Tg of the first polymeric material that is imprinted as part of formation of the first metastructure 120 is higher than the Tg of the second polymeric material that is imprinted as part of formation of the second metastructure 220. This feature can advantageous, for example, to help prevent deformation of the first polymeric material when the second polymeric material is imprinted. In some instances, the polymeric layers 104, 116 may be cured by different techniques. Thus, in some cases, the first polymeric layer may be cured by UV radiation, whereas the second polymeric layer may be cured thermally. This feature may be useful to prevent the first polymeric material from dissolving when the second polymeric material is spin-coated onto the first polymeric material.

In some implementations, the protective layer (i.e., 116 in FIG. 1D, or 216 in FIG. 2H) may be composed of a relatively hydrophobic or hydrophilic material. For example, where the top protective layer is hydrophilic and the metastructure device is incorporated as part of a light emitting module, the module may exhibit improved eye-safety (e.g., a water droplet would not act like a lens, but would spread out) the generated light). This feature can be useful, for example, where the metastructure device is incorporated into a module that has a laser or VCSEL as the light source (see, e.g., FIGS. 8, 10 and 11).

In some instances, the protective layer (i.e., 116 in FIG. 1D, or 216 in FIG. 2H) can have an antireflective coating on its surface, or may be structured to provide a specified optical effect. In some instances, an anti-reflective coating can be provided on the back side of the metastructure. For example, as indicated in FIG. 1D, an anti-reflective coating 118 can be incorporated onto either the front and/or back side of the substrate 102.

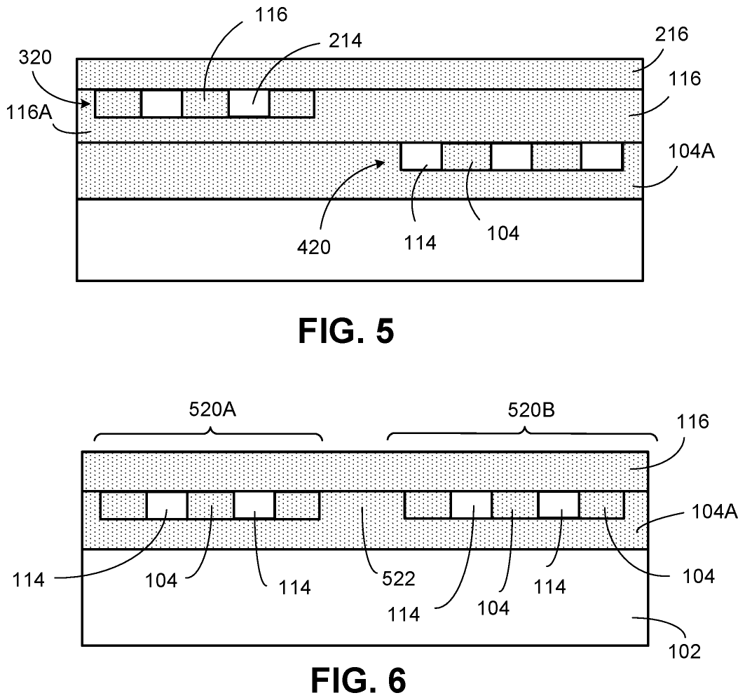

In the foregoing example of FIG. 3, the meta-atoms 114, 214 of the first and second metastructures 120, 220 may have substantially the same lateral dimensions, and the meta-atoms of one metastructure may be substantially aligned with respect to the meta-atoms of the other metastructure. In the example of FIG. 3, the second metastructure 220 completely overlaps the first metastructure 120. In other implementations, however, the overall lateral dimensions of the two metastructures may differ from one another. Thus, FIG. 4 illustrates an example in which the second metastructure 320 only partially overlaps the first metastructure 120. Further, in some instances, as shown in FIG. 5, the second metastructure 320 does not overlap the first metastructure 420 at all.

In the foregoing examples of FIGS. 3, 4 and 5, the first and second metastructures are in different planes from one another. In some instance, multiple metastructures 520A, 520B may be formed in the same plane as one another, but may be optically isolated from one another by an isolation region 522, as shown in the example of FIG. 6. Metal or other material for the isolation region 522 may be deposited, for example, on the substrate 102 prior to formation of the metastructures 520A, 520B. A mask or lift-off technique may be used to restrict the metal to the desired location. In other implementations, metal deposited on the backside of the substrate 102 may be provide optical isolation between the two metastructures 520A, 520B.

The foregoing optical devices can, in some cases, be fabricated using wafer-scale manufacturing processes, in other words, using processes that allow tens, hundreds or even thousands of optical devices to be manufactured in parallel at the same time.

In some implementations, optical devices incorporating one or more metastructures as described above may be integrated into modules that house one or more optoelectronic devices (e.g., light emitting and/or light sensing devices). The metastructure can be used to modify one or more characteristics (e.g., phase, amplitude, angle, etc.) of an emitted or incoming light wave as it passes through the metastructure.

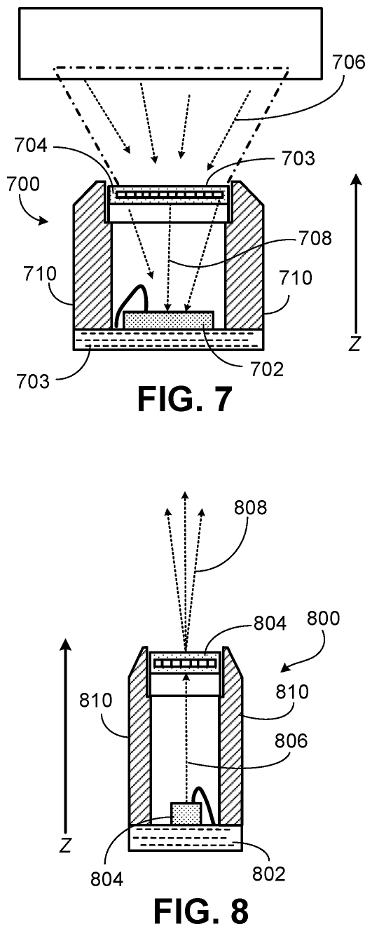

As shown, for example, in FIG. 7, in some implementations, a light sensing module (for example, an ambient light sensor module) 700 includes a light sensor (e.g., a photodiode, a pixel, or an image sensor) 702 mounted on a substrate 703. Light 706 incident on the module 700 is modified by a metastructure device 704, which may be implemented, for example, in accordance with any of the metastructure devices described above in connection with FIGS. 1A through 6. For single-channel modules, such as the module 700, the implementations of a metastructure device shown in FIGS. 1D, 2H or 3 may be particularly advantageous. The metastructure device 704 is disposed so as to intersect a path of the incoming light 706. The metastructure device 704 can modify one or more characteristics of the light 706 impinging on the metastructure device before the light 708 is received and sensed by the light sensor 702. In some instances, for example, the metastructure device 704 may focus patterned light onto the light sensor 702. In some instances, the metastructure device 704 may split, diffuse and/or polarize the light 706 before it is received and sensed by the light sensor 702. The module housing may include, for example, spacers 710 separating the light sensor 702 and/or the substrate 703 from the metastructure device 704. In some cases, the metastructure device 704 may help reduce the overall z-height of the module 700 compared to modules incorporating conventional optics, and may better protect the device in adverse environments.

In some implementations, a module 800 includes a substrate 802 and a light emitter 804 mounted on, or integrated in, the substrate 802. The light emitter 804 may include, for example, a laser (e.g., a vertical-cavity surface-emitting laser) or a light emitting diode. Light 806 generated by the light emitter 804 passes through a metastructure device 804 and out of the module. The metastructure device 804 may be implemented, for example, in accordance with any of the metastructure devices described above in connection with FIGS. 1A through 6. For single-channel modules, such as the module 800, the implementations of a metastructure device shown in FIGS. 1D, 2H or 3 may be particularly advantageous. The metastructure device 804 is disposed so as to intersect a path of the outgoing light 806. The metastructure device 804 can modify one or more characteristics of the light 806 impinging on the metastructure before the light 808 exits the module 800. Thus, the metastructure device 804 is operable to modify the light 806, such that modified light 808 is transmitted out of the module 800. In some cases, the module 800 is operable to produce, for example, one or more of structured light, diffused light, and patterned light. The module housing may include, for example, spacers 810 separating the light emitter 804 and/or the substrate 802 from the metastructure device 804. In some instances, the module 800 is operable as a light generating module, e.g., as a structured light projector, a camera flash, a logo projecting module or as a lamp.

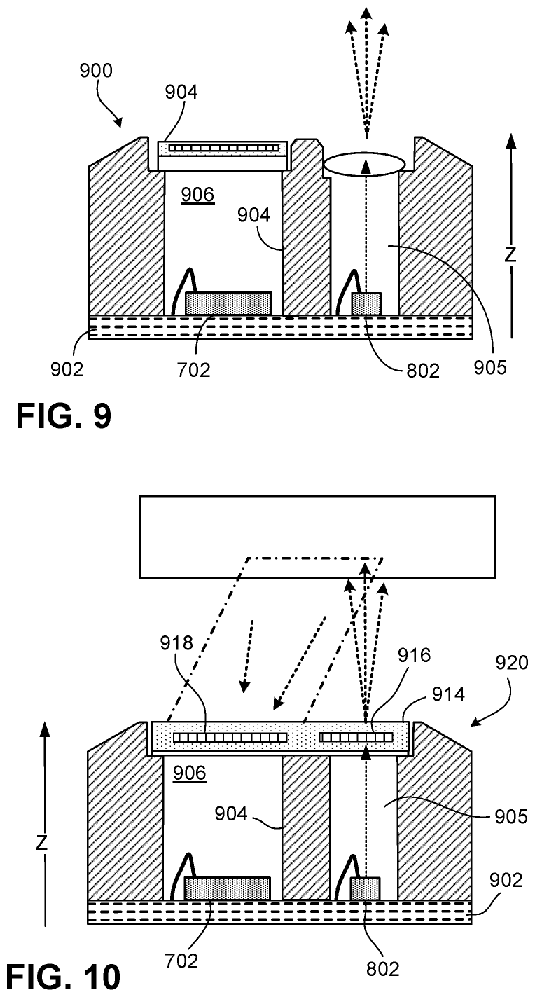

FIGS. 9, 10 and 11 illustrate examples of multi-channel modules that incorporate at least one metastructure device as described above. Each of the modules in FIGS. 9, 10 and 11 includes a light sensor 702 and a light emitter 802, both of which are mounted, for example, on the same printed circuit board (PCB) or other substrate 902. Each of the modules thus includes a light emission channel 905 and a light detection channel 906, which may be optically isolated from one another by a wall 904 that forms part of the module housing.

In some instances, the module includes a metastructure device over only one of the channels 905, 906. For example, as shown in FIG. 9, the module 900 includes a metastructure device 904 over the light detection channel 906, whereas there is a lens or other optical element disposed in the optical path of the of light emission channel 905. The metastructure device 904 may be implemented, for example, in accordance with any of the metastructure devices described above. In this case, as the metastructure device 904 extends over only a single optical channel, the implementations of a metastructure device shown in FIGS. 1D, 2H or 3 may be particularly advantageous. In some instances, only the light emission channel 905 may have a metastructure device disposed over (or in) it so as to intersect the outgoing light, whereas the light detection channel may have a lens or other optical element disposed over (or in) it instead.

The implementation of FIG. 9 may be advantageous, for example, for situations in which one of the channels requires less complicated optics (requiring a smaller z-height) than the other channel. In some cases, the more complicated optics can be implemented by the metastructure. Consequently, the module may have a smaller overall z-height. The module can be, in some cases, a three-dimensional camera such as a time-of-flight (TOF) camera, a stereo camera with active stereo (which may need another light sensitive channel), a structured-light camera with a structured light projector, an ordinary camera with flash, or a proximity sensing module.

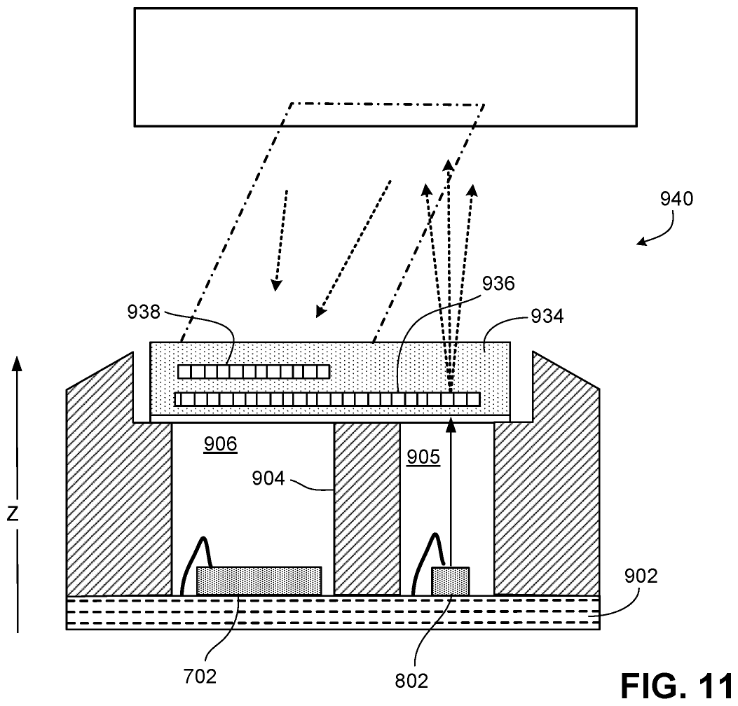

In some implementations, as shown in FIGS. 10 and 11, a single metastructure device spans across both channels 905, 906 such that each of the channels 905, 906 has at least one metastructure disposed over (or in) it. In some cases, as shown in FIG. 10, the metastructure device 914 includes first and second embedded metastructures 916, 918 in the same plane as one another. Thus, a first metastructure 916 is disposed over (or in) the emission channel 905, and a second, different metastructure 918 is disposed over (or in) the detection channel 906. In some implementations, the metastructure device of FIG. 6 is incorporated into the module 920 of FIG. 10. An advantage in some cases is that a single metastructure device 914 that spans both channels can be manufactured with better tolerances than if two separate metastructure devices were used, while at the same time allowing for each channel to have a respective metastructure tailored for its particular requirements.

In other implementations, as shown in the example of FIG. 11, the metastructure device 934 includes a first embedded metastructure 936 that spans both channels 905, 906, and a second embedded metastructure 938 that is disposed over (or in) only one of the channels (e.g., the light detection channel 906). Thus, one channel (e.g., the light detection channel 906) may have multiple embedded metastructures 936, 938 over (or in) the channel, whereas the other channel (e.g., the light emission channel 905) has only a single embedded metastructure 936 over (or in) the channel. In some implementations, the metastructure device of FIG. 4 is incorporated into the module 940 of FIG. 11. Here as well, an advantage in some cases is that a single metastructure device 934 that spans both channels can be manufactured with better tolerances than if two separate metastructure devices were used, while at the same time allowing for each channel to have a respective metastructure tailored for its particular requirements. Such an implementation can be advantageous, for example, when more complicated optics are needed for imaging and less complicated optics are needed for projecting light.

In some cases, in the implementations of FIG. 9, 10 or 11, the module may emit light that interacts with an object external to the module. Light reflected by the object then is received by the module, allowing the module to act, for example, as a proximity sensor or as a three-dimensional mapping device. When integrated into such a module, the metastructure device may provide one or more of the advantages described for the modules above.

Although the examples of FIGS. 9-11 illustrate modules having two optical channels, optical devices as described above also can be incorporated into modules having more than two optical channels. In some cases, the optical device may span across all the optical channels, whereas in other cases the optical device may span across fewer than all the channels. Respective metastructures in the optical device may be disposed so as intersect incoming or outgoing light from one or more of the optical channels.

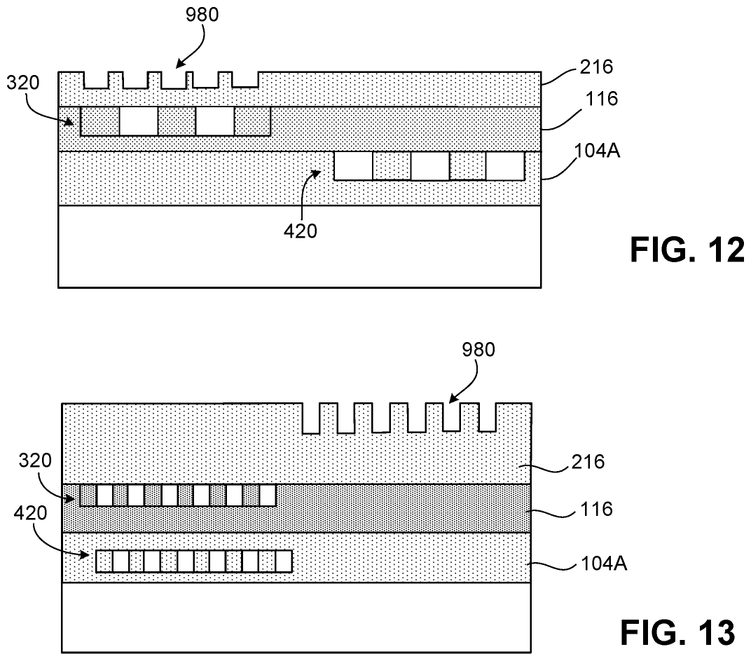

In some instances, a diffractive optical element (DOE) can be replicated into the top polymeric layer of the metastructure device. An example is shown in FIG. 12, which is similar to the metastructure of FIG. 5, but also includes a DOE replicated into the upper polymeric layer 216. Another example is shown in FIG. 13. The implementation of FIG. 13 can be useful, for example, in two-channel embodiments of modules where one channel includes a light source and a simple optic (i.e., the DOE) is needed for illuminating a scene, and the other channel includes an image sensor where more complicated optics are needed (i.e., the metastructures).

In some instances, the modules described above may be integrated into mobile phones, laptops, televisions, wearable devices, or automotive vehicles.

Various aspects of the subject matter and the functional operations described in this specification can be implemented in digital electronic circuitry, or in computer software, firmware, or hardware, including the structures disclosed in this specification and their structural equivalents, or in combinations of one or more of them. Thus, aspects of the subject matter described in this specification can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The apparatus can include, in addition to hardware, code that creates an execution environment for the computer program in question, e.g., code that constitutes processor firmware.

Although particular implementations have been described in detail, various modifications can be made. Accordingly, other implementations are within the scope of the claims.

1. A method of manufacturing an optical device comprising:
providing a substrate having a first polymeric layer on a surface of the substrate;
forming openings in the first polymeric layer;
depositing a material in the openings to form meta-atoms of a first metastructure, wherein adjacent ones of the meta-atoms are separated from one another by polymeric material of the first polymeric layer;
providing a second polymeric layer over the first metastructure; and
forming a second metastructure in the second polymeric layer.

2. The method of claim 1, wherein forming the second metastructure includes:
forming openings in the second polymeric layer; and
depositing a material in the openings of the second polymeric layer to form meta-atoms of the second metastructure, wherein adjacent ones of the meta-atoms of the second metastructure are separated from one another by polymeric material of the second polymeric layer.

3. The method of claim 1, wherein at least one of materials, dimensions or optical characteristics of the first and second metastructures differ from one another.

4. An optical device comprising:
a substrate;
a first metastructure disposed on the substrate, wherein the first metastructure includes a first plurality of meta-atoms separated from one another by polymeric material;
a second metastructure disposed over the substrate, wherein the second metastructure includes a second plurality of meta-atoms separated from one another by polymeric material, and wherein the second metastructure is separate from the first metastructure.

5. The optical device of claim 4, wherein the first and second metastructures are disposed in a same plane as one another.

6. The optical device of claim 5, wherein the first and second metastructures are separated from one another by an optical isolation region.

7. The optical device of claim 4, wherein the second metastructure is in a plane different from the first metastructure.

8. The optical device of claim 7, wherein the second metastructure at least partially overlaps a position of the first metastructure.

9. The optical device of claim 7, wherein the second metastructure does not overlap a position of the first metastructure.

10. The optical device of claim 4, wherein respective materials of the first and second metastructures differ from one another.

11. The optical device of claim 4, wherein respective dimensions of the first and second metastructures differ from one another.

12. The optical device of claim 4, wherein respective optical characteristics of the first and second metastructures differ from one another.

13. The optical device of claim 4 further including a protective layer over the second metastructure, wherein the protective layer has a hydrophobic or hydrophilic surface.

14. The optical device of claim 4 wherein meta-atoms of at least one of the first or second metastructures are composed of titanium dioxide.

15. A method of manufacturing an optical device comprising:
providing a substrate having a polymeric layer on a surface of the substrate;
forming openings in the polymeric layer;
depositing a material in the openings to form meta-atoms of a first metastructure, wherein adjacent ones of the meta-atoms are separated from one another by polymeric material of the first polymeric layer; and
providing a protective layer over the first metastructure, the protective layer having a hydrophobic or hydrophilic surface.

16. An optical device comprising:
a substrate;
a first metastructure disposed on the substrate, wherein the first metastructure includes a plurality of meta-atoms separated from one another by polymeric material; and
a protective layer over the first metastructure, wherein the protective layer has a hydrophobic or hydrophilic surface.

17. The optical device of claim 16 wherein the plurality of meta-atoms of the first metastructure are composed of titanium dioxide.

18. An apparatus comprising:
a housing;
an optoelectronic component operable to emit or sense light, wherein the optoelectronic component is disposed within the housing; and
an optical device according to claim 4, wherein the optical device is disposed over the optoelectronic component.

19. An apparatus comprising:
a housing;
an optoelectronic component operable to emit or sense light, wherein the optoelectronic component is disposed within the housing; and
an optical device according to claim 16, wherein the optical device is disposed over the optoelectronic component.
